(19) United States
(12) Patent Application Publication
(10) Pub. No.: US 2026/0370484 A1
(43) Pub. Date: Nov. 19, 2026

(54) PROOF AND VERIFICATION OF DATA STORAGE

(71) Applicant: nChain Licensing AG, Zug (CH)

(72) Inventors: Bassem AMMAR, London (GB); Craig Steven WRIGHT, London (GB)

(21) Appl. No.: 19/146,480

(22) PCT Filed: Jan. 10, 2024
(86) PCT No.: PCT/EP2024/050503

§ 371 Date: Jul. 8, 2025

(30) Foreign Application Priority Data
Jan. 25, 2023 (GB) 2301072.1

(51) Int. Cl. H04L 9/32; H04L 9/00

(52) U.S. Cl. CPC H04L 9/3236; H04L 9/3247; H04L 9/50

(57) ABSTRACT

A computer-implemented method for enabling verification of data storage, wherein the method comprises: obtaining a plurality of data blocks, wherein the plurality of data blocks together represent a data item to be stored by one or more respective second parties; for each respective second party, generating a respective hash root of a respective hash tree based on a respective set of data blocks of the plurality of data blocks, wherein each respective data block of the respective set of data blocks is used to generate a respective leaf hash of the respective hash tree; for each respective second party, submitting a respective request transaction to one or more blockchain nodes of a blockchain network, wherein the respective request transaction is a blockchain transaction configured to require a respective response transaction to comprise a respective hash proof for a respective leaf hash of the respective hash tree.

### CROSS REFERENCE TO RELATED APPLICATIONS

This application is the U.S. National Stage of International Application No. PCT/EP2024/050503 filed on Jan. 10, 2024, which claims the benefit of United Kingdom Patent Application No. 2301072.1, filed on Jan. 25, 2023, the contents of which are all incorporated herein by reference in their entireties.

### TECHNICAL FIELD

The present disclosure relates to methods of providing proof that data has been stored and enabling verification that data has been stored.

### BACKGROUND

In general there are three types of storage: block, file and object. Block storage stores a sequence of binary bits or bytes. Block storage offers the best read/write speeds and is suitable for databases with transactional workloads. For cloud-based services, block storage usually comes with a virtual compute unit (server) attached to it. File storage goes on top of block storage. That is, block storage is abstracted by a file system. This is ideal for use cases such as large content repositories, development environments, media stores, or directories.

Object storage is an alternative to file storage and goes on top of block storage, where data and metadata are stored together. It is ideal for modern applications that require scale and flexibility. It is also ideal for importing existing data stores for analytics, backup, or archive.

Redundant Array of Independent Disks (RAID) works by combining the space of multiple drives into a single logical drive and then spreading and/or replicating the data across the entire array. There are several RAID configurations. Each offers various levels of resilience (data retrievability in case of hard drives failure), and/or performance (the read/write throughput).

Storage providers store data on behalf of clients, e.g. users or companies. In a scenario where clients pay storage providers to store an amount of data for a period of time, storage providers may be required to periodically provide evidence that they still have the data, so that they can continue to be paid for the storage service.

### SUMMARY

According to one aspect disclosed herein, there is provided a computer-implemented method for enabling verification of data storage, wherein the method is performed by a first party and comprises: obtaining a plurality of data blocks, wherein the plurality of data blocks together represent a data item to be stored by one or more respective second parties; for each respective second party, generating a respective hash root of a respective hash tree based on a respective set of data blocks of the plurality of data blocks, wherein each respective data block of the respective set of data blocks is used to generate a respective leaf hash of the respective hash tree; for each respective second party, submitting a respective request transaction to one or more blockchain nodes of a blockchain network, wherein the respective request transaction is a blockchain transaction configured to require a respective response transaction to comprise a respective hash proof for a respective leaf hash of the respective hash tree.

According to another aspect disclosed herein, there is provided a computer-implemented method for providing proof of data storage, wherein the method is performed by a second party and comprises: obtaining a plurality of data blocks, wherein the plurality of data blocks together represent a data item stored by the second party; generating a hash tree based on a respective set of data blocks of the plurality of data blocks, wherein each respective data block of the respective set of data blocks is used to generate a respective leaf hash of the respective hash tree; obtaining a request transaction, wherein the request transaction is a blockchain transaction configured to require a response transaction to comprise a respective hash proof for a respective leaf hash of the respective hash tree; generating the respective hash proof; and submitting a response transaction to one or more blockchain nodes of a blockchain network, wherein the response transaction comprises the respective hash proof.

The present disclosure describes techniques for providing proof that a storage provider has stored data and for verifying that a storage provider has stored data. For each storage provider, a service provider (e.g. an Oracle) generates a hash tree (e.g. a Merkle tree) based on the data. To verify that a storage provider has stored the data, the service provider submits a request transaction to the blockchain network. The request transaction requires a response transaction to include a hash proof (e.g. a Merkle proof) for a leaf of the hash tree.

The storage provider, if they have stored the data, can generate the hash proof and thus generate and submit the response transaction to the blockchain network. Storage providers may be challenged to provide proofs that multiple copies of the data have been stored.

The service provider may periodically challenge the storage provider(s). Challenges made by the service provider may be in the form of a locking script, which can be unlocked by a storage provider providing the hash proof in an unlocking script.

Data provided to the storage provider is mapped into leaf nodes of a hash tree. Challenges may require the storage provider to provide a leaf node pre-image and a hash proof. Leaf nodes may be a cryptographic hash of a data block, where storage proofs include the data-block itself. The leaf nodes may also be a hash of an elliptic curve (EC) point generated from the data-block, where the storage proofs do not include the data-block but rather an EC-signature generated from the data-block.

Some embodiments of the present disclosure may be used to prevent storage providers from colluding to provide fake storage proofs of multiple copies while actually storing only a single copy of the data. Embodiments enable proof of storage without having to reveal the actual data.

### BRIEF DESCRIPTION OF THE DRAWINGS

To assist understanding of embodiments of the present disclosure and to show how such embodiments may be put into effect, reference is made, by way of example only, to the accompanying drawings in which:

FIG. 1 is a schematic block diagram of a system for implementing a blockchain,

FIG. 2 schematically illustrates some examples of transactions which may be recorded in a blockchain,

FIG. 3 is a schematic block diagram of an example system for storing data,

FIG. 4 is a sequence diagram for an example process for requesting and providing a storage proof, and

FIGS. 5 to 7 schematically illustrate example flows for providing data to storage providers.

### DETAILED DESCRIPTION OF EMBODIMENTS

### 1. Data Storage Proof

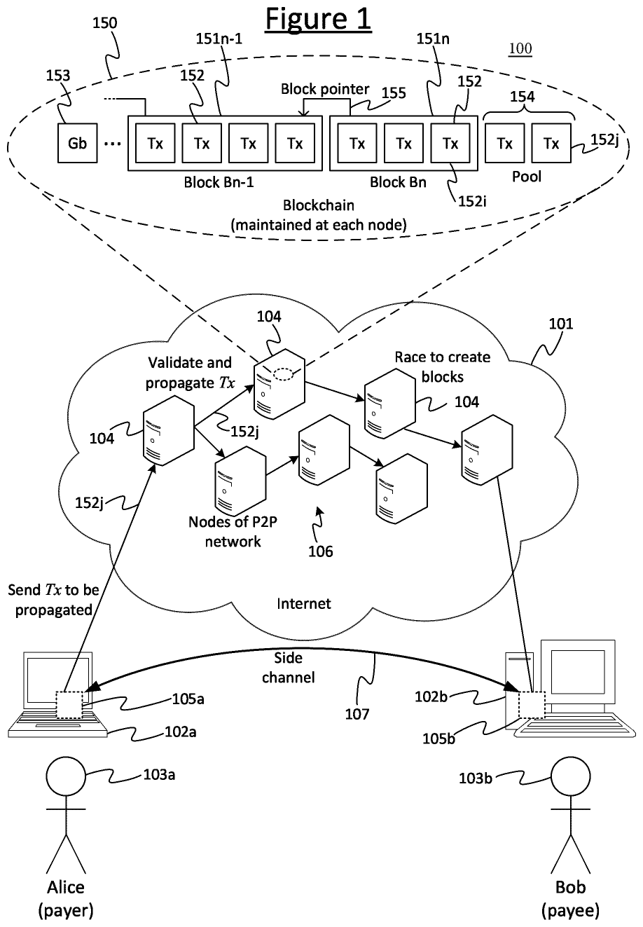

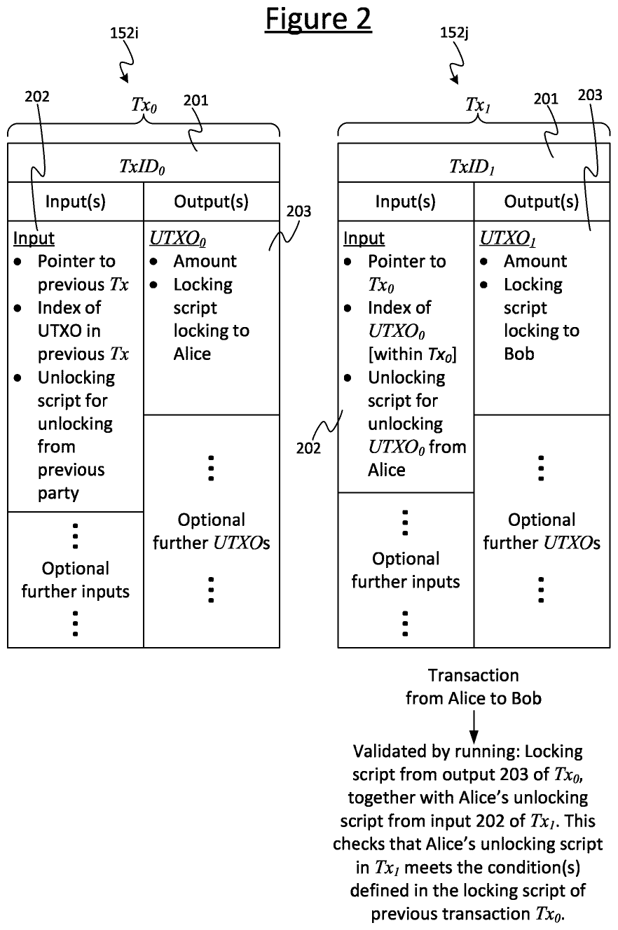

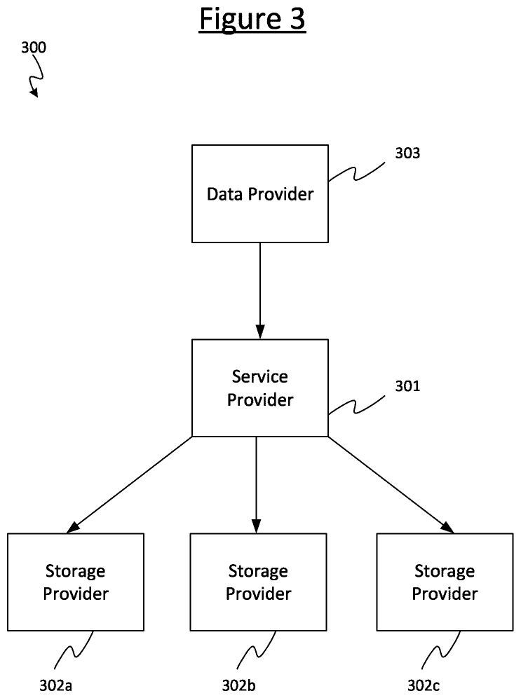

FIG. 3 shows an example system 300 for implementing the embodiments described herein. The system 300 includes a first party (a “service provider”) 301, one or more second parties (“storage providers”) 302 and a third party (a “data provider”) 303. In some examples, the data provider 303 and the service provider 301 may be the same entity. Each storage provider 302 is configured to store data, e.g. in local memory or in cloud storage. The service provider 301 and each storage provider 303 may take the form of Alice 103a and/or Bob 103b as described below with reference to FIGS. 1 and 2. That is, the service provider 301 and each storage provider 303 may be configured to perform some or all of the actions described below as being performed by Alice 103a and/or Bob 103b.

From the perspective of the service provider 301, the service provider 301 obtains a plurality of data blocks. The data blocks represent a data item to be stored by the storage provider(s) 302. The data provider 303 may send the data item and/or the plurality of data blocks to the service provider 301, or the service provider 301 may already have access to the data item and/or the data blocks. The data item may comprise, for example, an audio file, a video file, a document, an application file, etc.

The service provider 301 generates, for each storage provider 302, a respective Merkle tree based on a respective set of data blocks. In some examples, the same set of data blocks is used to generate each Merkle tree. In this case, only one Merkle tree may need to be generated which will be used for each storage provider 302. Alternatively, one or more respective Merkle trees may be generated based on a different set of data blocks. In some examples, each Merkle tree is generated based on a different set of data blocks.

Each data block of a respective set of data blocks is used to generate a respective leaf node (or leaf hash) of the respective Merkle tree. In some examples, the respective leaf node is generated by hashing a respective data block. Additional optional data, such as a random value, may be hashed together with the respective data block. In other examples, a respective public key is generated based on each respective data block, and the respective leaf node is generated by hashing the respective public key.

In some examples, each data block is encrypted to generate a respective encrypted data block. Some or all of the data blocks may be encrypted with the same encryption key, or with different encryption keys. In these examples, each respective Merkle tree is generated based on a respective set of encrypted data blocks. A respective leaf node may be generated by hashing a respective encrypted data block. Alternatively, a respective leaf node may be generated by hashing a public key corresponding to a respective encrypted data block.

One or more leaf nodes of a given Merkle tree may be based on data other than a data block, e.g. a salt, or an identifier mapped to the respective storage provider 302.

In some examples, some or all of the sets of data blocks include all of the plurality of data blocks. That is, a set of data blocks used to generate a Merkle tree may represent the complete data item. In some examples, some or all of the sets of data blocks do not include all of the plurality of data blocks. That is, a set of data blocks used to generate a Merkle tree may not represent the complete data item. For instance, the data item may be divided into a sequence of data blocks, each data block being assigned an index indicating the position of the data block in the sequence. A set of data blocks may include all data blocks having an even index, or all data blocks having an odd index. As another illustrative example, a set of data blocks may include half of the plurality of data blocks, whereas a different set of data blocks may include the remaining data blocks.

As mentioned, the service provider 301 generates a respective Merkle tree per respective storage provider 302, based on a respective set of data blocks. Each Merkle tree has a respective Merkle root. The service provider 301 also generates a respective request transaction per respective storage provider 302. Each request transaction generated for a respective storage provider 302 is configured to require a respective response transaction to include a respective Merkle proof for a respective leaf node of the respective Merkle tree generated for that storage provider 302. That is, in order for a response transaction to successfully validate when executed together with a request transaction, the response transaction must include a Merkle proof for a particular leaf node of a Merkle tree. The request transaction may include the Merkle root of the Merkle tree.

As an example, a request transaction may include a locking script that enforces the requirement that the response transaction includes the Merkle proof as part of an unlocking script of the response transaction.

The response transaction may be required to include a pre-image of the leaf node, e.g. the data block (or the encrypted data block) or the public key corresponding to the data block (or the encrypted data block). In some examples, the response transaction may be required to include a signature generated using the data block (or the encrypted data block).

The service provider 301 may send the data item and/or the plurality of blocks to the storage provider(s) 302. In some examples, the service provider 301 may send only the encrypted data item and/or the encrypted data blocks to the service provider(s) 302. The service provider 301 may send the respective Merkle root of the respective Merkle tree to the respective storage provider(s) 302.

Turning now to the perspective of a storage provider 302, the storage provider 302 obtains the plurality of data blocks representing the data item to be stored. The data blocks may be received from the service provider 301, or the data item may be received based on which the storage provider 302 generates the data blocks. The storage provider 302 generates a Merkle tree based on a set of data blocks from the plurality of data blocks in the same way in which the service provider 301 generates a corresponding Merkle tree for that storage provider 302. As discussed in relation to the service provider 301, the Merkle tree may be generated based on encrypted data blocks, which may be received from the service provider 301 or generated by the storage provider 302.

The storage provider 302 obtains a request transaction, e.g. from the service provider 301 or from the blockchain 150. As described above, the request transaction requires a Merkle proof to be provided by a response transaction. The storage provider 302 generates a suitable Merkle proof. The Merkle proof comprises a sequence of hashes connecting a leaf node of the generated Merkle tree to the Merkle roof of the Merkle tree. The storage provider 302 generates a response transaction that includes the Merkle proof, and submits the response transaction to the blockchain network 106. The response transaction references the request transaction. The Merkle proof may be included in an unlocking script of the response transaction, where the unlocking script is included in an input that references an output of the request transaction. If required, the response transaction may also include a pre-image of the leaf node for which the Merkle proof is provided and/or a signature generated using the data block on which the leaf node is based.

Note that whilst examples have been described in terms of Merkle trees, any suitable type of hash tree may be used.

Further specific examples of the embodiments described above are now provided.

### 1.1 Data Upload and Storage Proofs

This section describes how one or multiple copies of data may be stored at multiple storage providers 302. Storage proofs may make use of digital signatures, cryptographic hash functions, or a mixture of both.

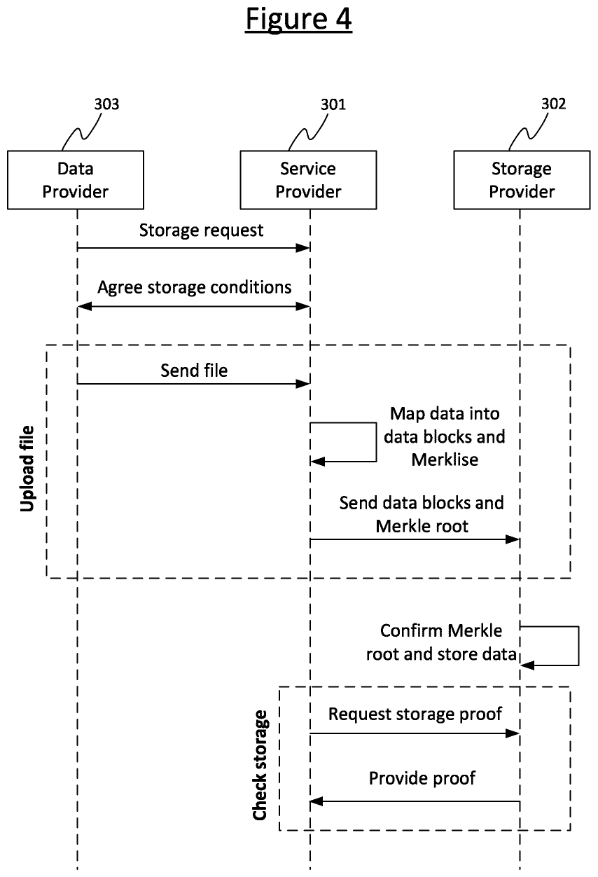

FIG. 4 shows an example overview of the interactions between a data provider (client) 303, service provider 301 and storage provider 302. The data provider 303 issues a storage request to the service provider 301. Storage conditions are agreed. The data provider 303 sends a file to the service provider 301 who maps the file into data blocks and generates a Merkle tree using the data blocks. The data blocks and Merkle root of the Merkle tree are sent to the storage provider 302. The storage provider 302 generates a Merkle tree using the data blocks and confirms that the Merkle root of the tree matches the received Merkle root. At a later time, the service provider 301 sends a request for a storage proof to the storage provider 302. The storage provider 302 responds with the requested proof.

The following example assumes that a client 303 has entered into agreement with an Oracle 301 to store data D for a time duration T. Based on the quality of service, there may be a single or several copies of D. It is also assumed that secure communication channels exist between the three actors, or at least between the client 303 and Oracle 301 and the between the Oracle 301 and the storage provider 302.

### 1.1.1 One Data Copy

In this example one storage provider (SP) 302 keeps only one copy of data.
1. The Oracle 301 prepares the data to be saved and divides D into an array of data blocks

D=(d₁,d₂, . . . ,dₘ)
2. The Oracle 301 maps the data blocks to leaves of Merkle Tree leafᵢ=fn(dᵢ), calculates the Merkle root rt, and sends data blocks to the SP 302 for storage.
3. The SP 302 stores D after recalculating the root and confirms it matches the value stored by the Oracle 301.

Note that data preparation may include one or more of: compressing the data, apply channel coding, and extracting data and metadata.

The Merkle tree leaf node may be given as
1. leafᵢ=Hash(dᵢ)
2. leafᵢ=Hash(Pᵢ=dᵢ×G), where G, Pᵢ are elliptic curve points.

The Oracle 301 keeps the Merkle root rt, and parameter m. Periodically the Oracle 301 requests storage proof from the SP 302. The Oracle 301 randomly selects i∈[1, m], and challenges the SP 302 to provide leaf; proof of storage. The proof of storage may comprise:
1. Merkle proof to calculate the tree root from leafᵢ
2. Pre-image of the leaf
3. Only if leafᵢ=Hash(Pᵢ), a message signed by dᵢ

Note that in the first case when the leaf is given by leafᵢ=Hashᵢ(dᵢ), the proof of storage requires providing the value of dᵢ. In the second case when leafᵢ=Hash(Pᵢ), the proof of storage does not reveal the actual value dᵢ.

The requested proof may be part of an unlocking script of a response transaction, and the validation of the Merkle path is included in the locking script of a request transaction.

As an example, assume the data has been divided into m=8 blocks and mapped into a Merkle tree as shown below:

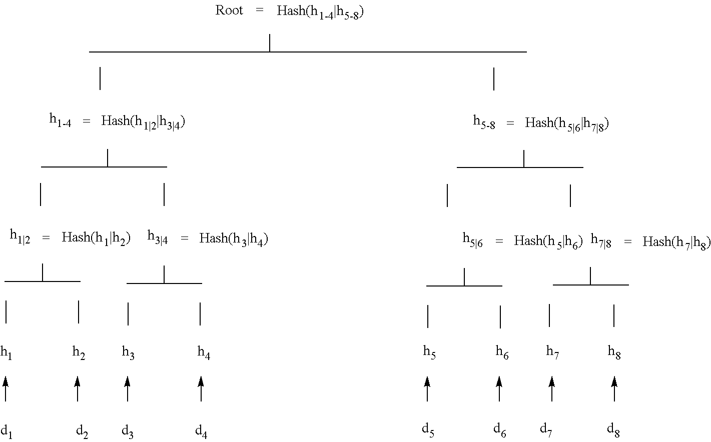

The following locking script can be unlocked by the unlocking script that contains d₃ and the Merkle proof that proves its link to the Merkle Tree Root.

Locking script

OP_SHA256 OP_SWAP OP_CAT OP_SHA256 OP_CAT
OP_SHA256 OP_SWAP OP_CAT OP_SHA256 <Root>
OP_EQUALVERIFY

Unlocking script

<h₅₋₈><h_{1|2}><h₄><d₃>

Script execution is shown in the following table.

| Main Stack | Script |
|---|---|
| | <h₅₋₈><h_{1\|2}><h₄><d₃> OP_SHA256 |
| | OP_SWAP OP_CAT OP_SHA256 OP_CAT OP_SHA256 |
| | OP_SWAP OP_CAT OP_SHA256 <Root> |
| | OP_EQUALVERIFY |
| <h₅₋₈><h_{1\|2}><h₄> | OP_SHA256 OP_SWAP OP_CAT OP_SHA256 OP_CAT |
| <d₃> | OP_SHA256 OP_SWAP OP_CAT OP_SHA256 |
| | <Root> OP_EQUALVERIFY |
| <h₅₋₈><h_{1\|2}><h₄> | OP_SWAP OP_CAT OP_SHA256 OP_CAT OP_SHA256 |
| <h₃> | OP_SWAP OP_CAT OP_SHA256 <Root> |
| | OP_EQUALVERIFY |
| <h₅₋₈><h_{1\|2}><h₃> | OP_CAT OP_SHA256 OP_CAT OP_SHA256 OP_SWAP |
| <h₄> | OP_CAT OP_SHA256 <Root> OP_EQUALVERIFY |
| <h₅₋₈><h_{1\|2}><h₃\|h₄> | OP_SHA256 OP_CAT OP_SHA256 OP_SWAP OP_CAT |
| | OP_SHA256 <Root> OP_EQUALVERIFY |
| <h₅₋₈><h_{1\|2}><h_{3\|4}> | OP_CAT OP_SHA256 OP_SWAP OP_CAT OP_SHA256 |
| | <Root> OP_EQUALVERIFY |
| <h₅₋₈><h_{1\|2}\|h_{3\|4}> | OP_SHA256 OP_SWAP OP_CAT OP_SHA256 < |
| | Root> OP_EQUALVERIFY |
| <h₅₋₈><h₁₋₄> | OP_SWAP OP_CAT OP_SHA256 <Root> |
| | OP_EQUALVERIFY |
| <h₁₋₄><h₅₋₈> | OP_CAT OP_SHA256 <Root> OP_EQUALVERIFY |
| <h₁₋₄\|h₅₋₈> | OP_SHA256 <Root> OP_EQUALVERIFY |
| <h₁₋₈> | <Root> OP_EQUALVERIFY |
| <h₁₋₈><Root> | OP_EQUALVERIFY |

True if the calculated value during script execution h₁₋₈ equals Root

When leaf is hash of elliptic curve point leafᵢ=hᵢ=Hash(dᵢ×G), the following locking script can be unlocked by the unlocking script that contains a signature that can only be produced from knowing dᵢ, without having to reveal dᵢ.

Locking script

OP_3 OP_PICK OP_SHA256 OP_SWAP OP_CAT OP_SHA256
OP_CAT OP_SHA256 OP_SWAP OP_CAT OP_SHA256 <Root>
OP_EQUALVERIFY OP_CHECKSIG

Unlocking script

<sig><P₃><h₅₋₈><h_{1|2}><h₄>

### 1.1.2 Multiple Data Copies

Having multiple copies of data is a more realistic and advisable scenario for data storage. Keeping more than one copy of the data and using more than one SP 302 improves resilience in case some copies are lost due to hardware failure, dropped connection or an SP 302 goes out of business. A copy of the data may be sent to each SP 302 and the Oracle 301 may challenge them periodically for proofs of storage as explained in the previous section.

However this does not prevent storage providers colluding to claim fees for multiple copies while storing less. To mitigate, each copy of the data may be encrypted differently to produce a different ciphertext. Challenges would require the SP 302 to provide the proof of storage of the ciphertext rather than the plaintext data. The SP 302 is not provided with access to the encryption and decryption keys.

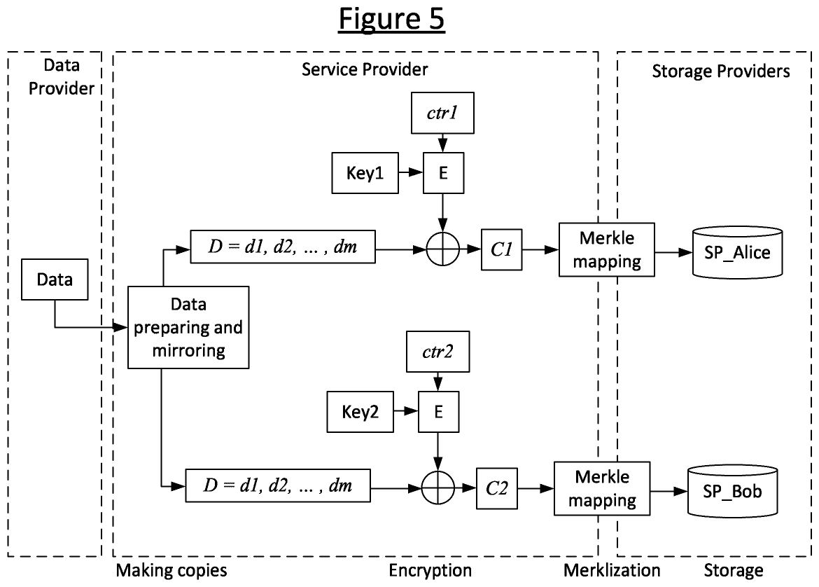

Another feature is that during data retrieval we may want to accelerate retrieval by concurrently downloading from multiple SPs, for example the possibility to download different data blocks from different SPs. To facilitate downloading different data blocks from different SPs 302, a stream cipher may be used with different keys. Applying a block cipher like AES in encryption modes counter (CTR) or Output feedback (OFB) makes a block cipher into a stream cipher. An illustrative example with two copies is shown in FIG. 5:
1. The Oracle 301 prepares the data to be saved and divides, D, into an array of data blocks D=(d₁, d₂, . . . , dₘ) and creates two copies.
2. The Oracle 301 encrypts the data D producing two different ciphertext C₁=ƒ(D, key₁), and C₂=ƒ(D, key₂). C₁, C₂ are the same size, where Cᵢ=(cᵢ₁, cᵢ₂, . . . , cᵢₘ), and i∈[1,2].
3. The Oracle 301 maps C₁, C₂ to the leaves of Merkle Trees T_{A}, T_{B}. Such that leaf_{A}_{ᵢ}=Hash(c₁ᵢ) and leaf_{B}_{ᵢ}=Hash (c₂ᵢ) i∈[1, m]. Note that for the case where ƒ( ) is a stream cipher and assuming we have D=(d₁, . . . , dₘ), it is possible to retrieve dx from cix if key; is known.
4. Each of SP₁, SP₂ stores C₁, C₂ respectively and their Merkle tree mapping. The Oracle 301 stores rt₁, rt₂, key₁, key₂.

Similar to the single copy use case, the Merkle tree leaf nodes may be a hash of the ciphertext or a hash of an EC-point (generated from the ciphertext).

When the leaf nodes are a hash of the ciphertext, leaves of trees T_{A} and T_{B} may be leaf_{A}_{ᵢ}=Hash(c₁ᵢ)=Hash(mᵢ⊕k₁ᵢ) and leaf_{B}_{ᵢ}=Hash(mᵢ⊕k₂ᵢ) where ⊕ is bit wise XOR operation and k₁ᵢ, k₂ᵢ are key material generated from the AES-ctr mode and function in the symmetric keys and counters settings. Both k₁ᵢ, k₂ᵢ can be re-generated by the oracle.

When the leaf nodes are a hash of EC-points, leafᵢ=Hash (cᵢ×G)=Hash(Pᵢ). The storage proof for a data-block may include:
1. Merkle proof for leafᵢ
2. Pre-image of the leaf, which will be EC-point Pᵢ
3. An ECDSA digital signature that can be verified with the EC-point Pᵢ as a public key

In some examples, during data upload the Oracle 301 creates multiple copies, then encrypts each copy with different keys and generates a Merkle Tree of each ciphertext C₁, C₂. This method allows re-use of the Merkle proofs within one tree. To illustrate a leaf of T_{A} is given by leaf_{A}_{ᵢ}=Hash(P_{A}_{ᵢ})=Hash(c₁ᵢ×G), where c₁ᵢ=(mᵢ⊕k₁ᵢ)mod n. Similarly a leaf of T_{B} is given by leaf_{B}=Hash(P_{B}_{ᵢ})=Hash(c₂ᵢ×G), where c₂ᵢ=(mᵢ⊕k₂ᵢ) mod n. A Merkle proof of leaf_{A}_{ᵢ} can be used in the Merkle proof of other leaves from T_{A}.

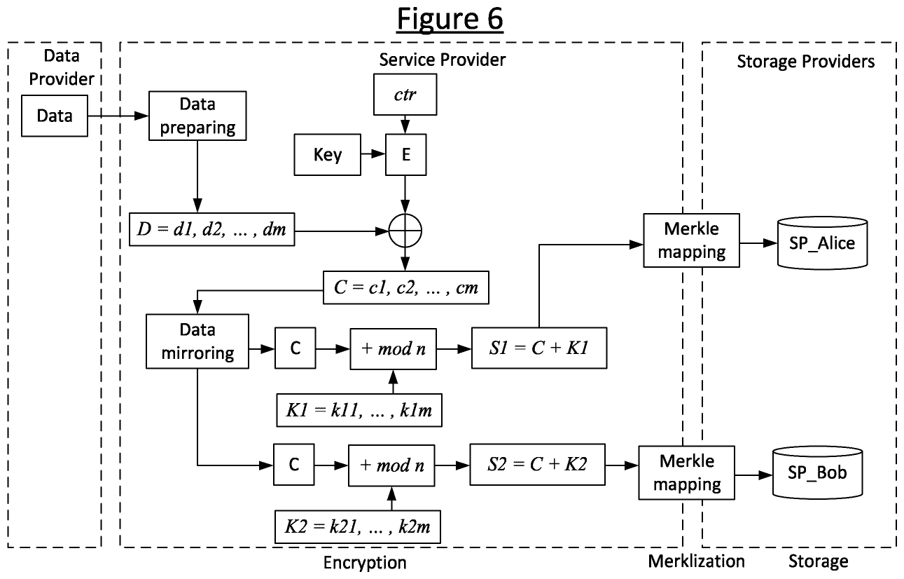

In other examples, a process shown in FIG. 6 is followed to allow re-use of Merkle proofs across different Merkle trees. During data upload, the Oracle 301 first encrypts the data using one single key generating one single ciphertext C, then creates multiple copies. For each copy of the ciphertext, the Oracle 301 adds mod n a different secret value K₁, K₂. Storage provider SP_{Alice} saves S₁=s₁₁, . . . , s₁ₘ, where s₁ᵢ=c₁+k₁ᵢ mod n, and a leafs of T_{A} is given by leaf_{A}_{ᵢ}=Hash(s₁ᵢ×G)=Hash((c₁+k₁ᵢ mod n)×G). Similarly for storage provider SP_{Bob} a leaf of T_{B} is given by leaf_{B}_{ᵢ}=Hash(s₂ᵢ×G)=Hash((c₂ᵢ+k₂ᵢ mod n)×G). Now a Merkle proof of leaf_{B}_{₄} given Merkle proof of leaf_{A}_{₃} can be given by

$${Mp}_{l e a {f}_{{B}_{4}} \vert M {p}_{l e a {f}_{{A}_{3}}}} = \{ {P}_{{B}_{4}} \} = \{ {s}_{2 , 4} \times G \} = \{ ( {c}_{2 , 4} + {k}_{2 , 4} ) \times G \} .$$

$$M {p}_{{A}_{4}} .$$

The Oracle 301 verifies the Merkle proof as follows:
1. Obtain P_{B}_{₄} from SP_{B}
2. Calculate Hash (P_{B}_{₄}+(k_{1,4}−k_{2,4})×G), and check if it equals leaf_{A}_{₄} in

### 1.2 Applying RAID and Encryption

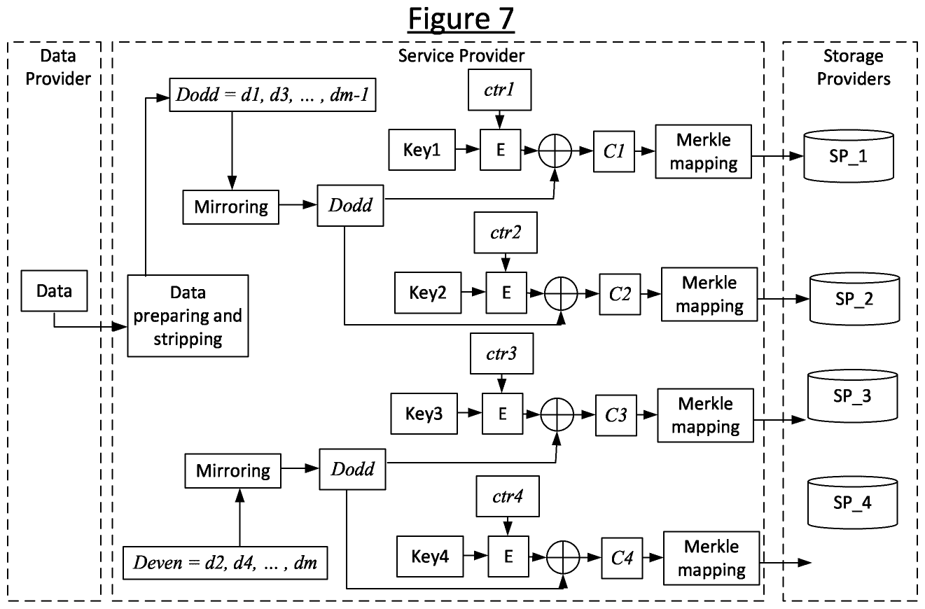

A RAID configuration that ensures data resilience may be chosen such that if one copy is lost the data can still be stored, and to allow fast access speed such that data read can be done in parallel. FIG. 7 illustrates an example of how to prepare data to be stored. First a RAID configuration is applied, then encryption, Merklization and storage. This example uses RAID (0+1), where data D is first stripped into two blocks D_{odd}, Dₑᵥₑₙ, then each block is mirrored, such that we have 4 data blocks D_{odd}, D_{odd}, Dₑᵥₑₙ, Dₑᵥₑₙ.

Each block is encrypted separately to produce the respective outputs C₁, C₂, C₃, C₄. Each Cᵢ is mapped into a Merkle Tree and then each Cᵢ and its mapping are sent to a SP 302. In FIG. 7, each Cᵢ has a different key (Keyi) and different starting ctrᵢ. Also note that the size of data strips dᵢ do not have to be 128-bits. Thus D_{odd}(and Dₑᵥₑₙ) may be divided into 128-bit blocks when being encrypted.

### 1.3 Race Based Storage Proofs and Data Retrievals

In the previous sections it is assumed that each challenge is customised to each SP, i.e. a transaction is made by the Oracle 301 a particular storage provider SP_{A}, who can unlock the transaction by providing a Merkle proof. However, a race condition may be created by the Oracle 301 between storage providers. The first SP 302 that provides the unlocking script wins the race. Such race transactions allow different storage providers 302 to make use of their bandwidth and availability of the data.

### 1.4 Data Retrieval

When a client 303 wants to retrieve the data, the Oracle 301 may connect to the SP 302 to facilitate retrieval of the data. The data can be sent off-chain or on-chain. Sending the data off-chain ensures data privacy when the stored data is not encrypted, and avoids having large transactions unnecessarily. Re-using previously sent Merkle proofs can allow to shorten new proof lengths. It is also possible that instead of sending the proof of each leaf pre-image, the SP sends a collection of consecutive leaves, and offer a single Merkle proof for the collection.

### 2. Example System Overview

A blockchain refers to a form of distributed data structure, wherein a duplicate copy of the blockchain is maintained at each of a plurality of nodes in a distributed peer-to-peer (P2P) network (referred to below as a “blockchain network”) and widely publicised. The blockchain comprises a chain of blocks of data, wherein each block comprises one or more transactions. Each transaction, other than so-called “coinbase transactions”, points back to a preceding transaction in a sequence which may span one or more blocks going back to one or more coinbase transactions. Coinbase transactions are discussed further below.

Transactions that are submitted to the blockchain network are included in new blocks. New blocks are created by a process often referred to as “mining”, which involves each of a plurality of the nodes competing to perform “proof-of-work”, i.e. solving a cryptographic puzzle based on a representation of a defined set of ordered and validated pending transactions waiting to be included in a new block of the blockchain. It should be noted that the blockchain may be pruned at some nodes, and the publication of blocks can be achieved through the publication of mere block headers.

The transactions in the blockchain may be used for one or more of the following purposes: to convey a digital asset (i.e. a number of digital tokens), to order a set of entries in a virtualised ledger or registry, to receive and process timestamp entries, and/or to time-order index pointers. A blockchain can also be exploited in order to layer additional functionality on top of the blockchain. For example, blockchain protocols may allow for storage of additional user data or indexes to data in a transaction. There is no pre-specified limit to the maximum data capacity that can be stored within a single transaction, and therefore increasingly more complex data can be incorporated. For instance this may be used to store an electronic document in the blockchain, or audio or video data.

In an “output-based” model (sometimes referred to as a UTXO-based model), the data structure of a given transaction comprises one or more inputs and one or more outputs. Any spendable output comprises an element specifying an amount of the digital asset that is derivable from the proceeding sequence of transactions. The spendable output is sometimes referred to as a UTXO (“unspent transaction output”). The output may further comprise a locking script specifying a condition for the future redemption of the output. A locking script is a predicate defining the conditions necessary to validate and transfer digital tokens or assets. Each input of a transaction (other than a coinbase transaction) comprises a pointer (i.e. a reference) to such an output in a preceding transaction, and may further comprise an unlocking script for unlocking the locking script of the pointed-to output. So consider a pair of transactions, call them a first and a second transaction (or “target” transaction). The first transaction comprises at least one output specifying an amount of the digital asset, and comprising a locking script defining one or more conditions of unlocking the output. The second, target transaction comprises at least one input, comprising a pointer to the output of the first transaction, and an unlocking script for unlocking the output of the first transaction.

In such a model, when the second, target transaction is sent to the blockchain network to be propagated and recorded in the blockchain, one of the criteria for validity applied at each node will be that the unlocking script meets all of the one or more conditions defined in the locking script of the first transaction. Another will be that the output of the first transaction has not already been redeemed by another, earlier valid transaction. Any node that finds the target transaction invalid according to any of these conditions will not propagate it (as a valid transaction, but possibly to register an invalid transaction) nor include it in a new block to be recorded in the blockchain.

An alternative type of transaction model is an account-based model. In this case each transaction does not define the amount to be transferred by referring back to the UTXO of a preceding transaction in a sequence of past transactions, but rather by reference to an absolute account balance. The current state of all accounts is stored by the nodes separate to the blockchain and is updated constantly.

FIG. 1 shows an example system 100 for implementing a blockchain 150. The system 100 may comprise a packet-switched network 101, typically a wide-area internetwork such as the Internet. The packet-switched network 101 comprises a plurality of blockchain nodes 104 (often referred to as “miners”) that may be arranged to form a peer-to-peer (P2P) network 106 within the packet-switched network 101. Whilst not illustrated, the blockchain nodes 104 may be arranged as a near-complete graph. Each blockchain node 104 is therefore highly connected to other blockchain nodes 104.

Each blockchain node 104 comprises computer equipment of a peer, with different ones of the nodes 104 belonging to different peers. Each blockchain node 104 comprises processing apparatus comprising one or more processors, e.g. one or more central processing units (CPUs), accelerator processors, application specific processors and/or field programmable gate arrays (FPGAs), and other equipment such as application specific integrated circuits (ASICs). Each node also comprises memory, i.e. computer-readable storage in the form of a non-transitory computer-readable medium or media. The memory may comprise one or more memory units employing one or more memory media, e.g. a magnetic medium such as a hard disk; an electronic medium such as a solid-state drive (SSD), flash memory or EEPROM; and/or an optical medium such as an optical disk drive.

The blockchain 150 comprises a chain of blocks of data 151, wherein a respective copy of the blockchain 150 is maintained at each of a plurality of blockchain nodes 104 in the distributed or blockchain network 106. As mentioned above, maintaining a copy of the blockchain 150 does not necessarily mean storing the blockchain 150 in full. Instead, the blockchain 150 may be pruned of data so long as each blockchain node 150 stores the block header (discussed below) of each block 151. Each block 151 in the chain comprises one or more transactions 152, wherein a transaction in this context refers to a kind of data structure. The nature of the data structure will depend on the type of transaction protocol used as part of a transaction model or scheme. A given blockchain will use one particular transaction protocol throughout.

A blockchain node 104 may be configured to forward transactions 152 to other blockchain nodes 104, and thereby cause transactions 152 to be propagated throughout the network 106. A blockchain node 104 may be configured to create blocks 151 and to store a respective copy of the same blockchain 150 in their respective memory. A blockchain node 104 may also maintain an ordered set (or “pool”) 154 of transactions 152 waiting to be incorporated into blocks 151. The ordered pool 154 is often referred to as a “mempool”. This term herein is not intended to limit to any particular blockchain, protocol or model. It refers to the ordered set of transactions which a node 104 has accepted as valid and for which the node 104 is obliged not to accept any other transactions attempting to spend the same output.

In a given present transaction 152j, the (or each) input comprises a pointer referencing the output of a preceding transaction 152i in the sequence of transactions, specifying that this output is to be redeemed or “spent” in the present transaction 152j. Spending or redeeming does not necessarily imply transfer of a financial asset, though that is certainly one common application. More generally spending could be described as consuming the output, or assigning it to one or more outputs in another, onward transaction. In general, the preceding transaction could be any transaction in the ordered set 154 or any block 151. The preceding transaction 152i need not necessarily exist at the time the present transaction 152j is created or even sent to the network 106, though the preceding transaction 152i will need to exist and be validated in order for the present transaction to be valid. Hence “preceding” herein refers to a predecessor in a logical sequence linked by pointers, not necessarily the time of creation or sending in a temporal sequence, and hence it does not necessarily exclude that the transactions 152i, 152j be created or sent out-of-order (see discussion below on orphan transactions). The preceding transaction 152i could equally be called the antecedent or predecessor transaction.

Due to the resources involved in transaction validation and publication, typically at least each of the blockchain nodes 104 takes the form of a server comprising one or more physical server units, or even whole a data centre. However in principle any given blockchain node 104 could take the form of a user terminal or a group of user terminals networked together.

The memory of each blockchain node 104 stores software configured to run on the processing apparatus of the blockchain node 104 in order to perform its respective role or roles and handle transactions 152 in accordance with the blockchain node protocol. It will be understood that any action attributed herein to a blockchain node 104 may be performed by the software run on the processing apparatus of the respective computer equipment. The node software may be implemented in one or more applications at the application layer, or a lower layer such as the operating system layer or a protocol layer, or any combination of these.

Any given blockchain node may be configured to perform one or more of the following operations: validating transactions, storing transactions, propagating transactions to other peers, performing consensus (e.g. proof-of-work)/mining operations. In some examples, each type of operation is performed by a different node 104. That is, nodes may specialise in particular operation. For example, a nodes 104 may focus on transaction validation and propagation, or on block mining. In some examples, a blockchain node 104 may perform more than one of these operations in parallel. Any reference to a blockchain node 104 may refer to an entity that is configured to perform at least one of these operations.

Also connected to the network 101 is the computer equipment 102 of each of a plurality of parties 103 in the role of consuming users. These users may interact with the blockchain network 106 but do not participate in validating transactions or constructing blocks. Some of these users or agents 103 may act as senders and recipients in transactions. Other users may interact with the blockchain 150 without necessarily acting as senders or recipients. For instance, some parties may act as storage entities that store a copy of the blockchain 150 (e.g. having obtained a copy of the blockchain from a blockchain node 104).

Some or all of the parties 103 may be connected as part of a different network, e.g. a network overlaid on top of the blockchain network 106. Users of the blockchain network (often referred to as “clients”) may be said to be part of a system that includes the blockchain network 106; however, these users are not blockchain nodes 104 as they do not perform the roles required of the blockchain nodes. Instead, each party 103 may interact with the blockchain network 106 and thereby utilize the blockchain 150 by connecting to (i.e. communicating with) a blockchain node 106. Two parties 103 and their respective equipment 102 are shown for illustrative purposes: a first party 103a and his/her respective computer equipment 102a, and a second party 103b and his/her respective computer equipment 102b. It will be understood that many more such parties 103 and their respective computer equipment 102 may be present and participating in the system 100, but for convenience they are not illustrated. Each party 103 may be an individual or an organization. Purely by way of illustration the first party 103a is referred to herein as Alice and the second party 103b is referred to as Bob, but it will be appreciated that this is not limiting and any reference herein to Alice or Bob may be replaced with “first party” and “second “party” respectively.

The computer equipment 102 of each party 103 comprises respective processing apparatus comprising one or more processors, e.g. one or more CPUs, GPUs, other accelerator processors, application specific processors, and/or FPGAs. The computer equipment 102 of each party 103 further comprises memory, i.e. computer-readable storage in the form of a non-transitory computer-readable medium or media. This memory may comprise one or more memory units employing one or more memory media, e.g. a magnetic medium such as hard disk; an electronic medium such as an SSD, flash memory or EEPROM; and/or an optical medium such as an optical disc drive. The memory on the computer equipment 102 of each party 103 stores software comprising a respective instance of at least one client application 105 arranged to run on the processing apparatus. It will be understood that any action attributed herein to a given party 103 may be performed using the software run on the processing apparatus of the respective computer equipment 102. The computer equipment 102 of each party 103 comprises at least one user terminal, e.g. a desktop or laptop computer, a tablet, a smartphone, or a wearable device such as a smartwatch. The computer equipment 102 of a given party 103 may also comprise one or more other networked resources, such as cloud computing resources accessed via the user terminal.

The client application 105 may be initially provided to the computer equipment 102 of any given party 103 on suitable computer-readable storage medium or media, e.g. downloaded from a server, or provided on a removable storage device such as a removable SSD, flash memory key, removable EEPROM, removable magnetic disk drive, magnetic floppy disk or tape, optical disk such as a CD or DVD ROM, or a removable optical drive, etc.

The client application 105 comprises at least a “wallet” function. This has two main functionalities. One of these is to enable the respective party 103 to create, authorise (for example sign) and send transactions 152 to one or more bitcoin nodes 104 to then be propagated throughout the network of blockchain nodes 104 and thereby included in the blockchain 150. The other is to report back to the respective party the amount of the digital asset that he or she currently owns. In an output-based system, this second functionality comprises collating the amounts defined in the outputs of the various 152 transactions scattered throughout the blockchain 150 that belong to the party in question.

Note: whilst the various client functionality may be described as being integrated into a given client application 105, this is not necessarily limiting and instead any client functionality described herein may instead be implemented in a suite of two or more distinct applications, e.g. interfacing via an API, or one being a plug-in to the other. More generally the client functionality could be implemented at the application layer or a lower layer such as the operating system, or any combination of these. The following will be described in terms of a client application 105 but it will be appreciated that this is not limiting.

The instance of the client application or software 105 on each computer equipment 102 is operatively coupled to at least one of the blockchain nodes 104 of the network 106. This enables the wallet function of the client 105 to send transactions 152 to the network 106. The client 105 is also able to contact blockchain nodes 104 in order to query the blockchain 150 for any transactions of which the respective party 103 is the recipient (or indeed inspect other parties' transactions in the blockchain 150, since in embodiments the blockchain 150 is a public facility which provides trust in transactions in part through its public visibility). The wallet function on each computer equipment 102 is configured to formulate and send transactions 152 according to a transaction protocol. As set out above, each blockchain node 104 runs software configured to validate transactions 152 according to the blockchain node protocol, and to forward transactions 152 in order to propagate them throughout the blockchain network 106. The transaction protocol and the node protocol correspond to one another, and a given transaction protocol goes with a given node protocol, together implementing a given transaction model. The same transaction protocol is used for all transactions 152 in the blockchain 150. The same node protocol is used by all the nodes 104 in the network 106.

An alternative type of transaction protocol operated by some blockchain networks may be referred to as an “account-based” protocol, as part of an account-based transaction model. In the account-based case, each transaction does not define the amount to be transferred by referring back to the UTXO of a preceding transaction in a sequence of past transactions, but rather by reference to an absolute account balance. The current state of all accounts is stored, by the nodes of that network, separate to the blockchain and is updated constantly.

In such a system, transactions are ordered using a running transaction tally of the account (also called the “position” or “nonce”). This value is signed by the sender as part of their cryptographic signature and is hashed as part of the transaction reference calculation. In addition, an optional data field may also be signed the transaction. This data field may point back to a previous transaction, for example if the previous transaction ID is included in the data field.

Some account-based transaction models share several similarities with the output-based transaction model described herein. For example, as mentioned above, the data field of an account-based transaction may point back to a previous transaction, which is equivalent to the input of an output-based transaction which references an outpoint a previous transaction. Thus both models enable linking between transactions. As another example, an account-based transaction contains a “recipient” field (in which a receiving address of an account is specified) and a “value” field (in which an amount of digital asset may be specified). Together the recipient and value fields are equivalent to the output of an output-based transaction which may be used to assign an amount of digital asset to a blockchain address. Similarly, an account-based transaction has a “signature” field which includes a signature for the transaction. The signature is generated using the sender's private key and confirms the sender has authorized this transaction. This is equivalent to an input/unlocking script of an output-based transaction which, typically, includes a signature for the transaction. When both types of transaction are submitted to their respective blockchain networks, the signatures are checked to determine whether the transaction is valid and can be recorded on the blockchain. On an account-based blockchain, a “smart contact” refers to a transaction that contains a script configured to perform one or more actions (e.g. send or “release” a digital asset to a recipient address) in response to one or more inputs (provided by a transaction) meeting one or more conditions defined by the smart contact's script. The smart contract exists as a transaction on the blockchain, and can be called (or triggered) by subsequent transactions. Thus, in some examples, a smart contract may be considered equivalent to a locking script of an output-based transaction, which can be triggered by a subsequent transaction, and checks whether one or more conditions defined by the locking script are met by the input of the subsequent transaction.

### 3. UTXO-Based Model

FIG. 2 illustrates an example transaction protocol. This is an example of a UTXO-based protocol. A transaction 152 (abbreviated “Tx”) is the fundamental data structure of the blockchain 150 (each block 151 comprising one or more transactions 152). The following will be described by reference to an output-based or “UTXO” based protocol. However, this is not limiting to all possible embodiments. Note that while the example UTXO-based protocol is described with reference to bitcoin, it may equally be implemented on other example blockchain networks.

In a UTXO-based model, each transaction (“Tx”) 152 comprises a data structure comprising one or more inputs 202, and one or more outputs 203. Each output 203 may comprise an unspent transaction output (UTXO), which can be used as the source for the input 202 of another new transaction (if the UTXO has not already been redeemed). The UTXO includes a value specifying an amount of a digital asset. This represents a set number of tokens on the distributed ledger. The UTXO may also contain the transaction ID of the transaction from which it came, amongst other information. The transaction data structure may also comprise a header 201, which may comprise an indicator of the size of the input field(s) 202 and output field(s) 203. The header 201 may also include an ID of the transaction. In embodiments the transaction ID is the hash of the transaction data (excluding the transaction ID itself) and stored in the header 201 of the raw transaction 152 submitted to the nodes 104.

Say Alice 103a wishes to create a transaction 152j transferring an amount of the digital asset in question to Bob 103b. In FIG. 2 Alice's new transaction 152j is labelled “Tx₁”. It takes an amount of the digital asset that is locked to Alice in the output 203 of a preceding transaction 152i in the sequence, and transfers at least some of this to Bob. The preceding transaction 152i is labelled “Tx₀” in FIG. 2. Tx₀ and Tx₁ are just arbitrary labels. They do not necessarily mean that Tx₀ is the first transaction in the blockchain 151, nor that Tx₁ is the immediate next transaction in the pool 154. Tx₁ could point back to any preceding (i.e. antecedent) transaction that still has an unspent output 203 locked to Alice.

The terms “preceding” and “subsequent” as used herein in the context of the sequence of transactions refer to the order of the transactions in the sequence as defined by the transaction pointers specified in the transactions (which transaction points back to which other transaction, and so forth). They could equally be replaced with “predecessor” and “successor”, or “antecedent” and “descendant”, “parent” and “child”, or such like. It does not necessarily imply an order in which they are created, sent to the network 106, or arrive at any given blockchain node 104. Nevertheless, a subsequent transaction (the descendent transaction or “child”) which points to a preceding transaction (the antecedent transaction or “parent”) will not be validated until and unless the parent transaction is validated. A child that arrives at a blockchain node 104 before its parent is considered an orphan. It may be discarded or buffered for a certain time to wait for the parent, depending on the node protocol and/or node behaviour.

One of the one or more outputs 203 of the preceding transaction Tx₀ comprises a particular UTXO, labelled here UTXO₀. Each UTXO comprises a value specifying an amount of the digital asset represented by the UTXO, and a locking script which defines a condition which must be met by an unlocking script in the input 202 of a subsequent transaction in order for the subsequent transaction to be validated, and therefore for the UTXO to be successfully redeemed.

The locking script (aka scriptPubKey) is a piece of code written in the domain specific language recognized by the node protocol. A particular example of such a language is called “Script” (capital S) which is used by the blockchain network. The locking script specifies what information is required to spend a transaction output 203, for example the requirement of Alice's signature. Locking scripts appear in the outputs of transactions. The unlocking script (aka scriptSig) is a piece of code written the domain specific language that provides the information required to satisfy the locking script criteria. For example, it may contain Bob's signature. Unlocking scripts appear in the input 202 of transactions.

So in the example illustrated, UTXO₀ in the output 203 of Tx₀ comprises a locking script [Checksig P_{A}] which requires a signature Sig P_{A} of Alice in order for UTXO₀ to be redeemed (strictly, in order for a subsequent transaction attempting to redeem UTXO₀ to be valid). [Checksig P_{A}] contains a representation (i.e. a hash) of the public key P_{A} from a public-private key pair of Alice. The input 202 of Tx₁ comprises a pointer pointing back to Tx₁ (e.g. by means of its transaction ID, TxID₀, which in embodiments is the hash of the whole transaction Tx₀). The input 202 of Tx₁ comprises an index identifying UTXO₀ within Tx₀, to identify it amongst any other possible outputs of Tx₀. The input 202 of Tx₁ further comprises an unlocking script <Sig P_{A}> which comprises a cryptographic signature of Alice, created by Alice applying her private key from the key pair to a predefined portion of data (sometimes called the “message” in cryptography). The data (or “message”) that needs to be signed by Alice to provide a valid signature may be defined by the locking script, or by the node protocol, or by a combination of these.

When the new transaction Tx₁ arrives at a blockchain node 104, the node applies the node protocol. This comprises running the locking script and unlocking script together to check whether the unlocking script meets the condition defined in the locking script (where this condition may comprise one or more criteria).

Note that the script code is often represented schematically (i.e. not using the exact language). For example, one may use operation codes (opcodes) to represent a particular function. “OP_. . . ” refers to a particular opcode of the Script language. As an example, OP_RETURN is an opcode of the Script language that when preceded by OP_FALSE at the beginning of a locking script creates an unspendable output of a transaction that can store data within the transaction, and thereby record the data immutably in the blockchain 150. E.g. the data could comprise a document which it is desired to store in the blockchain.

Typically an input of a transaction contains a digital signature corresponding to a public key P_{A}. In embodiments this is based on the ECDSA using the elliptic curve secp256k1. A digital signature signs a particular piece of data. In some embodiments, for a given transaction the signature will sign part of the transaction input, and some or all of the transaction outputs.

The particular parts of the outputs it signs depends on the SIGHASH flag. The SIGHASH flag is usually a 4-byte code included at the end of a signature to select which outputs are signed (and thus fixed at the time of signing).

The locking script is sometimes called “scriptPubKey” referring to the fact that it typically comprises the public key of the party to whom the respective transaction is locked. The unlocking script is sometimes called “scriptSig” referring to the fact that it typically supplies the corresponding signature. However, more generally it is not essential in all applications of a blockchain 150 that the condition for a UTXO to be redeemed comprises authenticating a signature. More generally the scripting language could be used to define any one or more conditions. Hence the more general terms “locking script” and “unlocking script” may be preferred.

### 4. Further Remarks

Other variants or use cases of the disclosed techniques may become apparent to the person skilled in the art once given the disclosure herein. The scope of the disclosure is not limited by the described embodiments but only by the accompanying claims.

For instance, some embodiments above have been described in terms of a bitcoin network 106, bitcoin blockchain 150 and bitcoin nodes 104. However it will be appreciated that the bitcoin blockchain is one particular example of a blockchain 150 and the above description may apply generally to any blockchain. That is, the present invention is in by no way limited to the bitcoin blockchain. More generally, any reference above to bitcoin network 106, bitcoin blockchain 150 and bitcoin nodes 104 may be replaced with reference to a blockchain network 106, blockchain 150 and blockchain node 104 respectively. The blockchain, blockchain network and/or blockchain nodes may share some or all of the described properties of the bitcoin blockchain 150, bitcoin network 106 and bitcoin nodes 104 as described above.

In preferred embodiments of the invention, the blockchain network 106 is the bitcoin network and bitcoin nodes 104 perform at least all of the described functions of creating, publishing, propagating and storing blocks 151 of the blockchain 150. It is not excluded that there may be other network entities (or network elements) that only perform one or some but not all of these functions. That is, a network entity may perform the function of propagating and/or storing blocks without creating and publishing blocks (recall that these entities are not considered nodes of the preferred bitcoin network 106).

In other embodiments of the invention, the blockchain network 106 may not be the bitcoin network. In these embodiments, it is not excluded that a node may perform at least one or some but not all of the functions of creating, publishing, propagating and storing blocks 151 of the blockchain 150. For instance, on those other blockchain networks a “node” may be used to refer to a network entity that is configured to create and publish blocks 151 but not store and/or propagate those blocks 151 to other nodes.

Even more generally, any reference to the term “bitcoin node” 104 above may be replaced with the term “network entity” or “network element”, wherein such an entity/element is configured to perform some or all of the roles of creating, publishing, propagating and storing blocks. The functions of such a network entity/element may be implemented in hardware in the same way described above with reference to a blockchain node 104.

Some embodiments have been described in terms of the blockchain network implementing a proof-of-work consensus mechanism to secure the underlying blockchain. However proof-of-work is just one type of consensus mechanism and in general embodiments may use any type of suitable consensus mechanism such as, for example, proof-of-stake, delegated proof-of-stake, proof-of-capacity, or proof-of-elapsed time. As a particular example, proof-of-stake uses a randomized process to determine which blockchain node 104 is given the opportunity to produce the next block 151. The chosen node is often referred to as a validator. Blockchain nodes can lock up their tokens for a certain time in order to have the chance of becoming a validator. Generally, the node who locks the biggest stake for the longest period of time has the best chance of becoming the next validator.

It will be appreciated that the above embodiments have been described by way of example only. More generally there may be provided a method, apparatus or program in accordance with any one or more of the following Statements.

Statement 1. A computer-implemented method for enabling verification of data storage, wherein the method is performed by a first party and comprises:
obtaining a plurality of data blocks, wherein the plurality of data blocks together represent a data item to be stored by one or more respective second parties;
for each respective second party, generating a respective hash root of a respective hash tree based on a respective set of data blocks of the plurality of data blocks, wherein each respective data block of the respective set of data blocks is used to generate a respective leaf hash of the respective hash tree;
for each respective second party, submitting a respective request transaction to one or more blockchain nodes of a blockchain network, wherein the respective request transaction is a blockchain transaction configured to require a respective response transaction to comprise a respective hash proof for a respective leaf hash of the respective hash tree.

The respective request transaction may comprise the respective hash root of the respective hash tree. For example, a locking script of the respective request transaction may comprise the respective hash root.

Statement 2. The method of statement 1, wherein for each respective hash tree:
each respective leaf hash that is based on a respective data block is generated by hashing at least the respective data block, or
each respective leaf hash that is based on a respective data block is generated by hashing a respective public key, wherein the respective public key is generated based on at least the respective data block and a generator point.

Statement 3. The method of statement 2, wherein each respective hash tree is based on a different respective value such that each respective hash root is a different hash root.

Statement 4. The method of statement 1, comprising:
generating one or more respective pluralities of encrypted data blocks, wherein each respective encrypted data block is generated based on a respective data block of the plurality of data blocks, and wherein for each respective hash tree:
each respective leaf hash that is based on a respective data block is generated by hashing at least the respective encrypted data block of a respective plurality of encrypted data blocks, or
each respective leaf hash that is based on a respective data block is generated by hashing a respective public key, wherein the respective public key is generated based on at least the respective encrypted data block of a respective plurality of encrypted data blocks and a generator point.

Statement 5. The method of statement 6, wherein each respective plurality of encrypted data blocks is generated based on a different encryption key.

Statement 6. The method of any preceding statement, wherein the respective request transaction is configured to require the respective response transaction to comprise a respective pre-image to the respective leaf hash.

Statement 7. The method of any preceding statement, wherein the respective request transaction is configured to require the respective response transaction to comprise a respective signature generated using the respective data block upon which the respective leaf hash is based.

Statement 8. The method of statement 4 or any statement dependent thereon, wherein the respective request transaction is configured to require the respective response transaction to comprise a respective signature generated using the respective encrypted data block upon which the respective leaf hash is based.

Statement 9. The method of any preceding statement, wherein each respective request transaction comprises a respective locking script, wherein the respective locking script is configured to enforce the requirement that the respective response transaction comprises the respective hash proof.

Statement 10. The method of any preceding statement, wherein said obtaining of the plurality of data blocks comprises receiving the plurality of data blocks from a third party, or receiving the data item from a third party and generating the plurality of data blocks.

Statement 11. The method of any preceding statement, comprising sending the data item and/or the plurality of data blocks to the one or more second parties.

Statement 12. The method of any preceding statement, comprising sending the respective hash root to the respective second party.

Statement 13. The method of statement 4 or any statement dependent thereon, comprising sending the respective plurality of encrypted data blocks to the respective second party.

Statement 14. The method of any preceding statement, wherein each respective set of data blocks of the plurality of data blocks comprises the same set of data blocks.

Statement 15. The method of statement 14, wherein each respective set of data blocks comprises all of the plurality of data blocks.

Statement 16. The method of any of statements 1 to 13, wherein at least two respective sets of data blocks of the plurality of data blocks comprise different sets of data blocks.

Statement 17. A computer-implemented method for providing proof of data storage, wherein the method is performed by a second party and comprises:
obtaining a plurality of data blocks, wherein the plurality of data blocks together represent a data item stored by the second party;
generating a hash tree based on a respective set of data blocks of the plurality of data blocks, wherein each respective data block of the respective set of data blocks is used to generate a respective leaf hash of the respective hash tree;
obtaining a request transaction, wherein the request transaction is a blockchain transaction configured to require a response transaction to comprise a respective hash proof for a respective leaf hash of the respective hash tree;
generating the respective hash proof; and
submitting a response transaction to one or more blockchain nodes of a blockchain network, wherein the response transaction comprises the respective hash proof.

Statement 18. The method of statement 17, wherein the request transaction is configured to require the response transaction to comprise a respective pre-image to the respective leaf hash, and wherein the method comprises:
generating the respective pre-image, wherein the response transaction comprises the respective pre-image.

Statement 19. The method of statement 17 or statement 18, wherein the request transaction is configured to require the response transaction to comprise a respective signature generated using the respective data block upon which the respective leaf hash is based, and wherein the method comprises:
generating the respective signature, wherein the response transaction comprises the respective signature.

Statement 20. The method of statement 17 or statement 18, comprising:
obtaining a plurality of respective encrypted data blocks, wherein each respective encrypted data block is generated based on a respective data block of the plurality of data blocks, and wherein:
each respective leaf hash that is based on a respective data block is generated by hashing at least a respective encrypted data block of the plurality of encrypted data blocks, or
each respective leaf hash that is based on a respective data block is generated by hashing a respective public key, wherein the respective public key is generated based on at least the respective encrypted data block of the plurality of encrypted data blocks and a generator point,
wherein the request transaction is configured to require the response transaction to comprise a respective signature generated using the respective encrypted data block upon which the respective leaf hash is based, and wherein the method comprises:
generating the respective signature, wherein the response transaction comprises the respective signature.

Statement 21. Computer equipment comprising:
memory comprising one or more memory units; and
processing apparatus comprising one or more processing units, wherein the memory stores code arranged to run on the processing apparatus, the code being configured so as when on the processing apparatus to perform the method of any of statements 1 to 20.

Statement 22. A computer program embodied on computer-readable storage and configured so as, when run on one or more processors, to perform the method of any of statements 1 to 20.

According to another aspect disclosed herein, there may be provided a method comprising the actions of the first party and the second party. According to another aspect disclosed herein, there may be provided a system comprising the computer equipment of the first party and the second party.

1. A computer-implemented method for enabling verification of data storage, wherein the method is performed by a first party and comprises:
obtaining a plurality of data blocks, wherein the plurality of data blocks together represent a data item to be stored by one or more respective second parties;
for each respective second party, generating a respective hash root of a respective hash tree based on a respective set of data blocks of the plurality of data blocks, wherein each respective data block of the respective set of data blocks is used to generate a respective leaf hash of the respective hash tree;
for each respective second party, submitting a respective request transaction to one or more blockchain nodes of a blockchain network, wherein the respective request transaction is a blockchain transaction configured to require a respective response transaction to comprise a respective hash proof for a respective leaf hash of the respective hash tree.

2. The method of claim 1, wherein for each respective hash tree:
each respective leaf hash that is based on a respective data block is generated by hashing at least the respective data block, or
each respective leaf hash that is based on a respective data block is generated by hashing a respective public key, wherein the respective public key is generated based on at least the respective data block and a generator point.

3. The method of claim 2, wherein each respective hash tree is based on a different respective value such that each respective hash root is a different hash root.

4. The method of claim 1, comprising:
generating one or more respective pluralities of encrypted data blocks, wherein each respective encrypted data block is generated based on a respective data block of the plurality of data blocks, and wherein for each respective hash tree:
each respective leaf hash that is based on a respective data block is generated by hashing at least the respective encrypted data block of a respective plurality of encrypted data blocks, or
each respective leaf hash that is based on a respective data block is generated by hashing a respective public key, wherein the respective public key is generated based on at least the respective encrypted data block of a respective plurality of encrypted data blocks and a generator point.

5. The method of claim 4, wherein each respective plurality of encrypted data blocks is generated based on a different encryption key.

6. The method of claim 1, wherein the respective request transaction is configured to require the respective response transaction to comprise a respective pre-image to the respective leaf hash.

7. The method of claim 1, wherein the respective request transaction is configured to require the respective response transaction to comprise a respective signature generated using the respective data block upon which the respective leaf hash is based.

8. The method of claim 4, wherein the respective request transaction is configured to require the respective response transaction to comprise a respective signature generated using the respective encrypted data block upon which the respective leaf hash is based.

9. The method of claim 1, wherein each respective request transaction comprises a respective locking script, wherein the respective locking script is configured to enforce the requirement that the respective response transaction comprises the respective hash proof.

10. The method of claim 1, wherein said obtaining of the plurality of data blocks comprises receiving the plurality of data blocks from a third party, or receiving the data item from a third party and generating the plurality of data blocks.

11. The method of claim 1, comprising sending the data item and/or the plurality of data blocks to the one or more second parties.

12. The method of claim 1, comprising sending the respective hash root to the respective second party.

13. The method of claim 4, comprising sending the respective plurality of encrypted data blocks to the respective second party.

14. The method of claim 1, wherein each respective set of data blocks of the plurality of data blocks comprises the same set of data blocks.

15-16. (canceled)

17. A computer-implemented method for providing proof of data storage, wherein the method is performed by a second party and comprises:
obtaining a plurality of data blocks, wherein the plurality of data blocks together represent a data item stored by the second party;
generating a hash tree based on a respective set of data blocks of the plurality of data blocks, wherein each respective data block of the respective set of data blocks is used to generate a respective leaf hash of the respective hash tree;
obtaining a request transaction, wherein the request transaction is a blockchain transaction configured to require a response transaction to comprise a respective hash proof for a respective leaf hash of the respective hash tree;
generating the respective hash proof; and
submitting a response transaction to one or more blockchain nodes of a blockchain network, wherein the response transaction comprises the respective hash proof.

18. The method of claim 17, wherein the request transaction is configured to require the response transaction to comprise a respective pre-image to the respective leaf hash, and wherein the method comprises:
generating the respective pre-image, wherein the response transaction comprises the respective pre-image.

19. The method of claim 17, wherein the request transaction is configured to require the response transaction to comprise a respective signature generated using the respective data block upon which the respective leaf hash is based, and wherein the method comprises:
generating the respective signature, wherein the response transaction comprises the respective signature.

20. The method of claim 17, comprising:
obtaining a plurality of respective encrypted data blocks, wherein each respective encrypted data block is generated based on a respective data block of the plurality of data blocks, and wherein:
each respective leaf hash that is based on a respective data block is generated by hashing at least a respective encrypted data block of the plurality of encrypted data blocks, or
each respective leaf hash that is based on a respective data block is generated by hashing a respective public key, wherein the respective public key is generated based on at least the respective encrypted data block of the plurality of encrypted data blocks and a generator point,
wherein the request transaction is configured to require the response transaction to comprise a respective signature generated using the respective encrypted data block upon which the respective leaf hash is based, and wherein the method comprises:
generating the respective signature, wherein the response transaction comprises the respective signature.

21. Computer equipment comprising:
memory comprising one or more memory units; and
processing apparatus comprising one or more processing units, wherein the memory stores code arranged to run on the processing apparatus, the code being configured so as when run on the processing apparatus, the processing apparatus performs a method for enabling verification of data storage, wherein the method is performed by a first party and comprises:
obtaining a plurality of data blocks, wherein the plurality of data blocks together represent a data item to be stored by one or more respective second parties;
for each respective second party, generating a respective hash root of a respective hash tree based on a respective set of data blocks of the plurality of data blocks, wherein each respective data block of the respective set of data blocks is used to generate a respective leaf hash of the respective hash tree;
for each respective second party, submitting a respective request transaction to one or more blockchain nodes of a blockchain network, wherein the respective request transaction is a blockchain transaction configured to require a respective response transaction to comprise a respective hash proof for a respective leaf hash of the respective hash tree.

22. A non-transitory computer readable medium, comprising a computer program configured so as, when run on one or more processors, the one or more processors perform a method for enabling verification of data storage, wherein the method is performed by a first party and comprises:
obtaining a plurality of data blocks, wherein the plurality of data blocks together represent a data item to be stored by one or more respective second parties;
for each respective second party, generating a respective hash root of a respective hash tree based on a respective set of data blocks of the plurality of data blocks, wherein each respective data block of the respective set of data blocks is used to generate a respective leaf hash of the respective hash tree;
for each respective second party, submitting a respective request transaction to one or more blockchain nodes of a blockchain network, wherein the respective request transaction is a blockchain transaction configured to require a respective response transaction to comprise a respective hash proof for a respective leaf hash of the respective hash tree.
